(19) United States
(12) Patent Application Publication
(10) Pub. No.: US 2003/0231238 A1
(43) Pub. Date: Dec. 18, 2003

(54) Mobile videoconferencing system

(75) Inventors: Mark A. Chew, West Chester, OH (US); Kevin Andrew Lowe, Cincinnati, OH (US)

Correspondence Address: FROST BROWN TODD LLC, 2200 PNC Center, 201 E. Fifth Street, Cincinnati, OH, 45202-4182, US

(73) Assignee: On Sight Communications, Inc.

(21) Appl. No.: 10/339,919

(22) Filed: Jan. 10, 2003

Related U.S. Application Data
(60) Provisional application No. 60/388,448, filed on Jun. 13, 2002.

(51) Int. Cl. H04N 7/14

(52) U.S. Cl. 348/14.02

(57) ABSTRACT

A wireless mobile videoconferencing system is provided for video, audio, and data communication that is both two-way and mobile, and in communication with other videoconferencing systems around that world. In particular, a mobile teleconferencing system includes a Very Small Aperture Antenna (VSAT) that is in satellite communication with a Technical Operations Center (TOC), which in turn is connected to the public switched telephone network (PSTN) and the Internet. Additional mobility is gained by a portable teleconferencing system (e.g., rollaway self-powered system, briefcase system) that is in wireless communication with the mobile teleconferencing system. Thus, audio, video, telephone, and data communication can be achieved in locations inaccessible to even a vehicle and without electrical power. The mobile videoconferencing system has applications to telemedicine, distance education, business communication, crisis response (e.g., disaster, vehicle crashes, hazardous material spills), crime scene investigations, construction sites, legal consultations and proceedings, and among many others.

### CROSS REFERENCE TO RELATED APPLICATIONS

The present application hereby claims the benefit of the provisional patent application entitled “Mobile Videoconferencing System” to Mark Chew et al., Serial. No. 60/388,448, filed on Jun. 13, 2002.

### FIELD OF THE INVENTION

The present invention relates, in general, to systems that transmit two-way video, audio, and data between a fixed site and a mobile site via a satellite link, and in particular to systems that further communicate to other fixed sites via the public telecommunications infrastructure.

### BACKGROUND OF THE INVENTION

Increasingly, businesses rely upon two-way teleconferencing in lieu of the expense and inconvenience of travel. For instance, a large number of businesses and institutions use RS366 standard videoconferencing systems that communicate across ISDN (Integrated Switched Digital Networks) and telephone lines. In addition, as businesses upgrade their data transmission network capacity, there is a growing trend for using H.320/323 standard videoconferencing systems (Digital Visual Communication) that communicate across these digital networks. Such digital approaches allow integrating additional capabilities, such as telephone, data and document transmission between locations.

Communication infrastructures that use ISDN telephone and data networks are being installed in many locations. However, often such terrestrial communication links are unavailable. For example, ISDN access is limited to 18,000 feet from a central office, so in rural areas an expensive T1 link has to be installed. In particular, many areas are too remote or have not been retrofitted with such links. Even in highly industrialized countries, it may take weeks or months to schedule the installation of such communication links. In addition, a one-time or intermittent use of the facility for teleconferencing may not make it worthwhile to install such links.

Satellite communication been employed to a limited extent to overcome unavailability of terrestrial communication links and to provide immediate access to broadband communication. However, the available approaches are either technically inferior or prohibitively expensive and complicated.

As a low-end option, video and audio have been transmitted over satellite telephone or cellular telephone systems. The low bandwidth of these telephone system restricts the transmission to a very low-resolution video signal. Such systems have been conspicuously used by journalists in austere environments to provide a rudimentary video signal for news broadcasts.

At the other extreme, a satellite news gathering (SNG) broadcasting station is often installed in a full-length semi-tractor trailer to obtain a degree of mobility. A large satellite antenna communicates via a geosynchronous satellite to a fixed broadcasting location. Such full broadcast suites are driven around the country for use at sporting events, political conventions, and other regionally or nationally televised events. The emphasis is on providing broadcast quality video and audio one way back to the fixed broadcasting station. These trailers typically contract satellite operators for 4.5 to 18 megabytes per second of bandwidth, at a large cost.

Thus, there is a large terrestrial communication infrastructure of videoconferencing systems, telephone, data networks, etc. Businesses and institutions use these communication links for two-way high-resolution audio and video transmission, Internet access, presentation visual graphics, telephone communication, email, and facsimile documents. However, these land-based solutions are limited to fixed locations and require significant amounts of time to add new locations. Television broadcasters have elaborate mobile platforms that are capable of one-way high-resolution audio and video transmission to a fixed broadcast station. Service and equipment providers generally have expertise in either the terrestrial, videoconferencing and telecommunication systems or have expertise in satellite communication. No one provides a satisfactory end-to-end solution for business quality of higher remote videoconferencing.

In the recent past, we have discovered that satellite based communication is a feasible and economical approach to linking a remote site to a terrestrial videoconference site. We discovered that data latency end-to-end through such a system was not insurmountable. In particular, FIG. 1 depicts a universal conferencing system 10 that we built employing a two-way, bit-based satellite communication channel 12 between a remote bit-based system and a technical operations center (TOC) 16. The TOC 16 arranges with a satellite operator to have two narrowband (e.g., 384 k-bits wide each) channels available on a geosynchronous communication satellite 18 during a given time slot, each channel with a carrier signal. One channel (“B1”) is for the TOC 16 to send video and audio to the remote bit-based system 14 and the other channel (“B2”) is for the TOC 16 to receive video and audio from the remote bit-based system 14. The remote bit-based system 14 was advantageously installed in a truck van 20.

The TOC 16 included an internal bit-based network 22 that interfaced the satellite communication channel 12 to a terrestrial communication network, depicted as an ISDN Public Switched Telephone Network (PSTN) 24. Through the ISDN PSTN 24, numerous fixed videoconference (VTC) stations 26 may be linked. Video and audio originating from the fixed VTC station 26 passes through the ISDN PSTN 24 to the internal bit-based network 22, which comprises an IMUX (RS366-RS422) Interface 28 coupled to a bit-based satellite modem 30 coupled to a transceiver 32 coupled to a fixed satellite antenna 34. The visual and audio data is thereafter uplinked from the fixed satellite antenna 34 to the satellite 18 and then downlinked to the remote bit-based system 14. Similarly, video and data originating at the remote bit-based system 14 is transferred in the reverse direction through the same equipment and infrastructure, sans the buffer 52.

The remote bit-based system 14 had an internal communication network 36 that coupled to the satellite communication channel 12. Specifically, a remote videoconference (VTC) station 38 was coupled to a bit-based satellite modem 40 that was coupled through a transceiver 42 to a Very Small Aperture Terminal (VSAT) antenna 44 for transmission to and from the satellite 18.

Aligning the VSAT antenna 44 was performed with reference to a map coordinate/satellite position lookup table 46. By reviewing a map or Global Positioning System, the current latitude and longitude coordinates for the remote bit-based system 14 were ascertained. From these coordinates, the azimuth, elevation, and polarity of the satellite 18 are given by the table 46. Then, manual motorized antenna positioning mechanisms 48 were adjusted to approximately position the VSAT antenna 44. Then, small adjustments to the positioning mechanisms 48 were made to scan for the exact position while monitoring an Intermediate Frequency (IF) with a carrier signal analyzer 50. The dual carrier signals may be inadvertently similar on multiple satellites. Consequently, it was imperative that the satellite 18 be confirmed with an elaborate frequency band depiction. Due to the time required for the bit-based satellite modem 40 to lock onto a signal, often the manual motorized alignment would require an hour or more, even by trained personnel.

Although alignment took some time, the teleconferencing system 38 from the remote bit-based system 14 successfully communicated with the fixed VTC 26, albeit with several inconveniences. Occasionally, intermittent delays/jitter in the satellite communication channel 12 caused the communication to be lost, exceeding some handshaking requirement in the interchange. Consequently, we discovered that inserting a buffer 52 between the IMUX Interface 28 and the bit-based satellite modem 30 prevented these occasional drop-offs.

Another inconvenience was not so easily remedied. The bit-based satellite communication channel 12 did not provide the ISDN functionality for dialing the fixed VTC station 26. Thus, personnel had to staff the TOC 16 when a VTC session was to be established. An ISDN dialing device 54, such as a VT100 terminal set to terminal mode to avoid timing out and hanging up, was used at the TOC 16 to link to the desired fixed VTC station 26, with the linking having to be completed within network time-out limits.

Additionally, often the preferred remote location is not readily accessible to the remote bit-based system unit 14, requiring the remote VTC station 38 to be connected to the mobile unit 14 via a cable. In many instances, routing cable from the remote VTCN 38 to the mobile unit 14 may be undesirable.

Furthermore, although video and audio from a remote location is very desirable, often other types of communication from a remote site are needed. Many applications require exchange of documentary material, digital data, VOIP, Internet, etc.

Thus, although the bit-based universal conferencing system 10 had great utility, a significant need exists for an improved system that can interact with the large terrestrial communication infrastructure, yet be readily and economically set up at a remote locations for two-way, high resolution audio and video communication.

### BRIEF SUMMARY OF THE INVENTION

The invention overcomes the above-noted and other deficiencies of the prior art by providing a complete solution, taking advantage of the existing network of videoconferencing, telephone and digital data systems and satellite communications. Mobility and two-way video, audio and data communication are provided between two sites, at least one of which is at a remote site without access to terrestrial communication links, such as ISDN (Integrated Switched Digital Networks) or digital data networks (e.g., Internet, Ethernet Local Area Network). A system and method provide the full end-to-end solution including mobile satellite delivered communications to leverage the current ISDN and Digital Visual Communication (DVC) equipment that many companies and institutions currently have.

In another aspect of the invention, a remote teleconferencing system is presented for two-way audio, video and data communication with a videoconferencing device that is in electronic communication with a terrestrial communication network. A technical operation center exchanges the data communication between a communication satellite and the terrestrial communication network. A mobile teleconferencing system communicates with the communication satellite to the technical operations center, and thus to the terrestrial communication network. Thereby, the mobile teleconferencing system can take full advantage of resources on the terrestrial communication network.

In another aspect of the invention, a method is described for remote teleconferencing two-way audio, video and data communication. Communication is made between a communication satellite and a terrestrial communication network, and transmission is of two-way audio, video and data communication is made with the communication satellite from a remote location. Thereby, full advantage of teleconferencing is made at a remote site to the many resources on terrestrial communication networks.

In yet another aspect of the invention, a method is given for aligning a Very Small Aperture Terminal (VSAT) antenna for two-way video, audio, and data communication for remote teleconferencing. A determination is made of a first frequency and a second frequency characteristic of a two-way satellite communication channel. A scan is made of the VSAT antenna to detect a first carrier signal at the first frequency and the second carrier signal at a second frequency. Then a fine tune scan is made with the VSAT antenna to increase a sensed power of the first and second carrier signals. Thereby, the cumbersome and complicated monitoring of the Intermediate Frequency output of a receiver with an expensive spectrum analyzer is avoided. In addition, human error that results in an inappropriate transmission to the wrong satellite is also made less likely. Furthermore, trained personnel are not required to perform this setup.

In yet an additional aspect of the invention, a mobile teleconferencing apparatus for communicating via a broadcast electromagnetic signal to a terrestrial communication network is described as including a satellite antenna, a transceiver coupled to the satellite antenna, a satellite modem operable to interface to the broad electromagnetic signals via the transceiver and satellite antenna, a remote data network coupled to the satellite modem; and a teleconferencing system coupled to the remote data network. Such an apparatus lends itself to ready transport to a remote site and is flexibly configured for using many systems that are already configured for use with a data network.

In yet a further aspect of the invention, a portable device for being worn by an individual, dog or remotely controlled platform is in wireless communication with a mobile teleconferencing apparatus. Thereby, videoconferencing capability may be delivered to otherwise inaccessible locations. For example, a rescue canine may be outfitted with a wearable interactive companion (WIC) portable unit. The audio and video transmitted by the WIC back to the mobile unit allows a user to direct the canine by return audio commands. Once the canine has reached a victim, a wireless display unit may be accessed by the victim to report back, not only to the mobile unit buck via satellite to any terrestrial teleconferencing system. As another example, an individual may walk or climb or perform other tasks yet be in full audio, visual and data communication via a mobile unit.

These and other objects and advantages of the present invention shall be made apparent from the accompanying drawings and the description thereof.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is diagram of a bit-based mobile teleconferencing system that demonstrates communication between a terrestrial videoconference site and a satellite linked mobile videoconference site.

FIG. 2 is a diagram of a packet-based mobile teleconferencing system that demonstrates wireless two-way video/audio/data communication between an office-in-a-box portable unit to a mobile communication office (MCO) mobile unit, and satellite and terrestrial communication in turn to a terrestrial videoconference site, PSTN, or Internet/Intranet access.

FIG. 3 is a diagram of a packet-based mobile teleconferencing system with a transportable communication system (TCS) mobile unit and a video interactive companion (VIC) portable unit.

FIG. 6 is a diagram of a wearable interactive companion (WIC) portable unit for wireless two-way video, audio and data communication with a mobile unit.

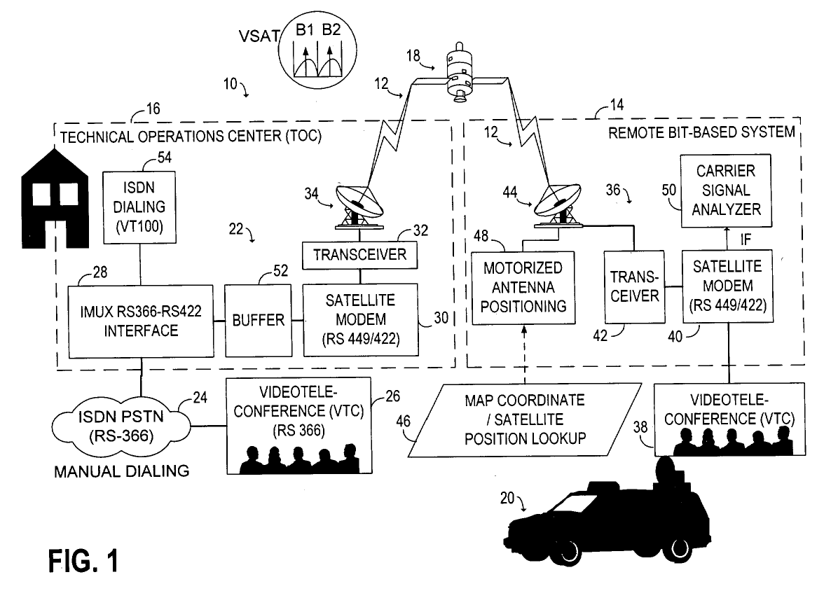

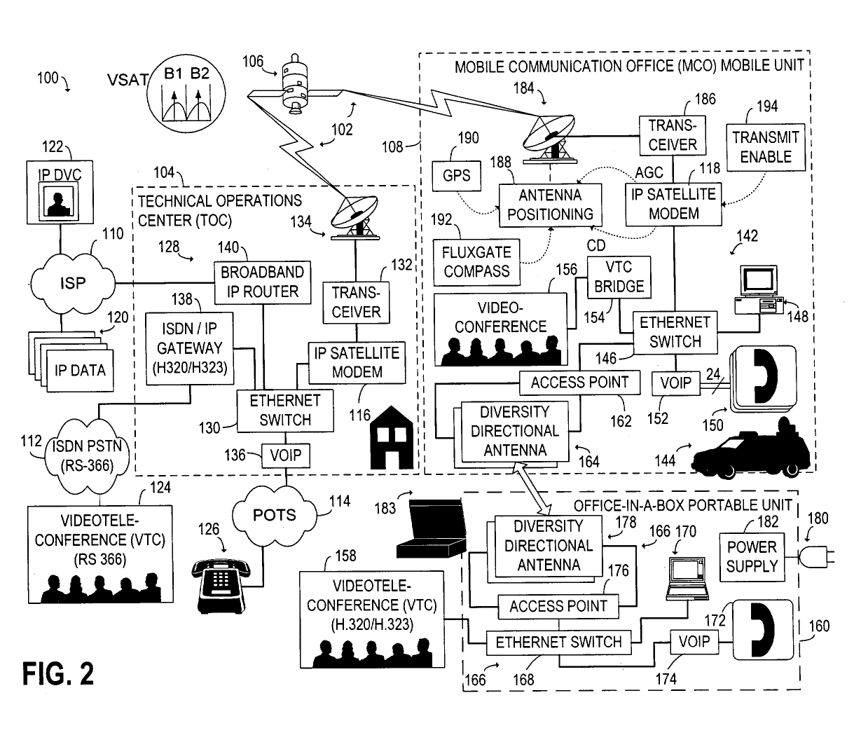

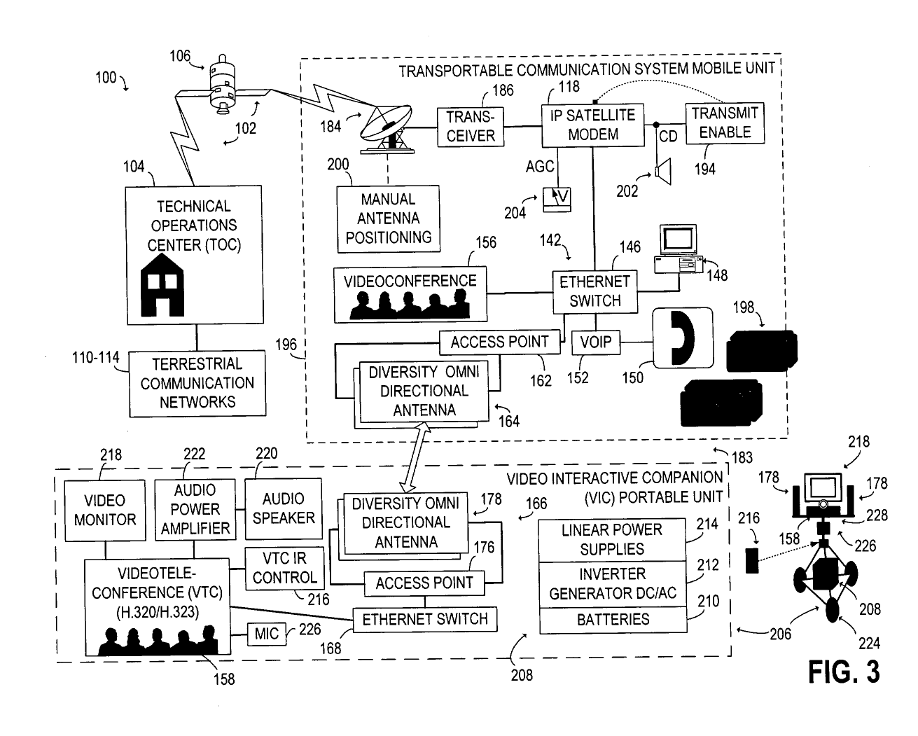

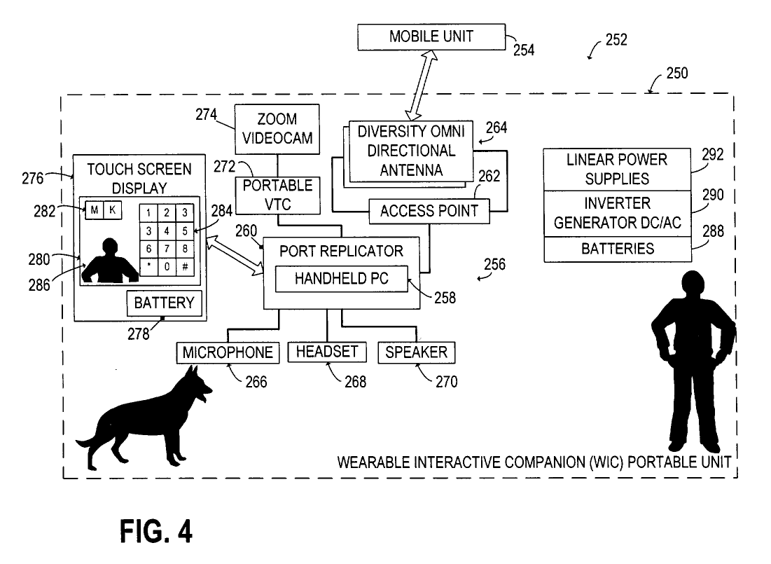

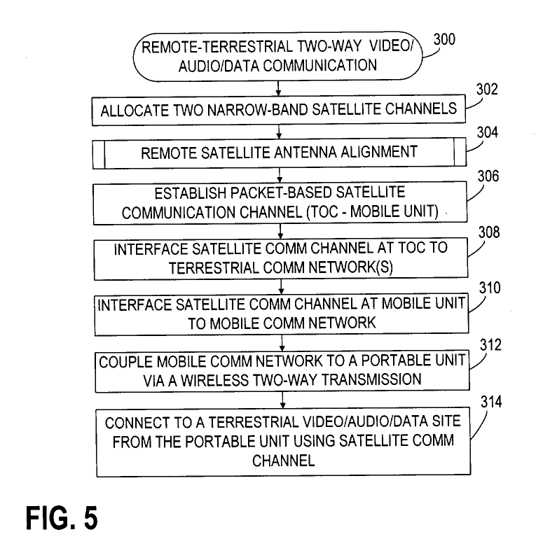

FIG. 5 is a flow diagram of a sequence of operations performed by the packet-based mobile teleconferencing system of FIGS. 2-3 for communication between a terrestrial fixed video teleconference (VTC) station to a mobile unit and advantageously further to a portable unit.

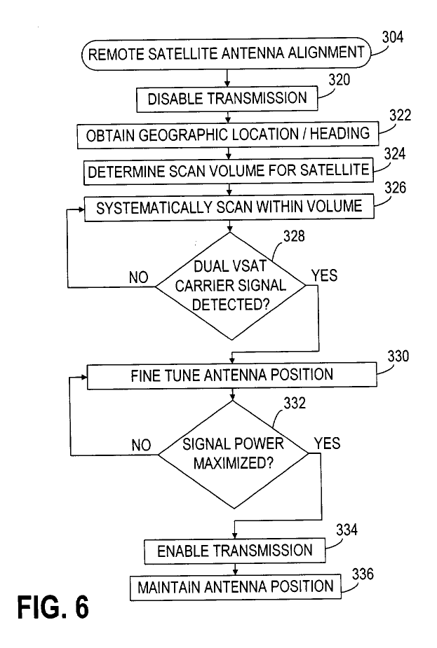

FIG. 6 is a flow diagram of a sequence of operations referenced in FIG. 4 for aligning a mobile Very Small Aperture Terminal (VSAT) antenna to the dual carrier satellite signal.

### DETAILED DESCRIPTION OF THE INVENTION

FIG. 2 depicts a universal teleconferencing system 100 that provides two-way video, audio and data communication from a remote location to the numerous locations connected to the public communication infrastructure (e.g., tapping into all the standard H.320 video conferencing systems that currently exist throughout the world). Setting up at the remote site is simple and quick, even for a non-technically trained individual, including even satellite antenna alignment. The remote portions of the system are self-contained and readily movable. Clear audio and video quality is provided. Embodiments that are installed in a truck van take advantage of the small size of a Very Small Aperture Terminal (VSAT) antenna and the other equipment, thus, allowing a video teleconference (VTC) and other office accouterments inside of the van. Moreover, the end-to-end solution meets the long felt need with a cost effective approach, enabling use in a wide range of applications such as distance education, telemedicine, conferencing, legal consultations and proceedings, investigations, mishap/disaster response, maritime multi-format communication, and news reporting.

The universal teleconferencing system 100 employs an Internet Protocol (IP) packet-based satellite communication channel 102 between a Technical Operations Center (TOC) 104, a geosynchronous communication satellite 106, and a mobile unit, depicted as a Mobile Communication Office (MCO) mobile unit 108. The IP-based satellite communication channel 102 supports high-quality video, audio and data content, including the ability to address public data networks, such as an Internet Service Provider (ISP) 110, an ISDN (Integrated Switched Digital Networks) Public Switched Telephone Network (PSTN) 112, and a Plain Old Telephone System (POTS) 114. Thus, the mobile unit 108 is capable of initiating communications without having to contact the TOC 104 through alternate means, nor having to necessarily staff the TOC 104 for such purposes.

Recently, prototype packet-based satellite IP modems became available, such as the Comtech EF Data, Model CiM-550, Tempe, Ariz. We found numerous advantages by replacing our previous bit-based satellite modems with an IP satellite modem 116 at the TOC 104 and an IP satellite modem 118 in the mobile unit 108. Specifically, the mobile unit 108 thereafter could address IP-based data networks, such as a Uniform Resource Locator (URL) through the ISP 110 to IP data 120 (e.g., web content) or to an IP Digital Visual Communication (DVC) system 122. The IP satellite modem 118 also supports digital dialing by an ISDN/IP gateway through the ISDN PSTN 112 to a fixed VTC station 124. The IP satellite modem 118 also supports analog dialing through a Voice-Over-IP interface through the POTS 114 to an analog telephone 126.

The TOC 104 interfaces between the IP satellite communication channel 102 and these terrestrial communication networks 110-114 with an internal digital network 128, depicted as an Ethernet network managed by an Ethernet switch 130. The IP satellite modem 116 communicates with the Ethernet switch 130 and also to a transceiver 132 that transmits and receives through a satellite antenna 134 to the satellite 106.

The internal digital network 128 further includes a Voice Over-IP interface 136 that couples the Ethernet Switch 130 to the POTS 114, an ISDN/IP Gateway (H.320/H.323) 138 that couples the Ethernet Switch 130 to the ISDN PSTN 112, and a broadband IP router 140 that couples the Ethernet switch 130 to the ISP 110. Thereby, the TOC 104 is fully interactive with a wide range of terrestrial communication networks that can be accessed by the mobile unit 108 as if the mobile unit 108 was co-located with the TOC 104.

The MCO mobile unit 108 incorporates its own internal digital network 142 into a vehicle, such as truck van 144, so that a user has available the full range of business communication means at whatever remote location is reachable by the van 144. An Ethernet switch 146, coupled to the IP satellite modem 118, manages the internal digital network 142. IP data is accessible in the MCO mobile unit 108 via a computer 148 that is coupled to the Ethernet switch 146. One or more telephones 150 are coupled to the Ethernet switch 146 via a Voice Over IP (VOIP) interface 152. Alternatively, IP telephones may be coupled to the Ethernet switch 146 directly. An illustrative depiction of twenty-four VOIP lines suggests applications such as mishap or disaster response when a command center is needed at a remote site.

One or more videoconferences may be merged by a VTC bridge 154 that is also connected to the Ethernet switch 146. For instance, one VTC station 156 may be install in the van 144. Advantageously, another VTC station 158 is coupled by wireless transmission to the mobile unit 108 via a portable unit, depicted as an office-in-a-box portable unit 160. Thereby, even more remote locations may be reached that are not within proximity to the mobile unit 108. For instance, an accident scene may not be accessible by vehicles. As another example, the remote site may be within a building and routing cables to the interior of the building is inconvenient. The wireless communication between the mobile unit 108 and portable unit 160 is facilitated in the mobile unit 108 by an access point 162 (e.g., Symbol Technologies, Inc., Model AP 4121 or 4131) coupled to the Ethernet switch 146. Two diversity high-gain omni-directional antennas 164 coupled to the access point 162 optimize reception in azimuth by selective phase shifting between the antennas 164.

The portable unit 160 as depicted having equipment selected to be hand carried in a single container. In particular, the portable unit 160 includes an internal digital network 166 facilitated by an Ethernet switch 168. IP data is accessible via a laptop PC 170 coupled to the Ethernet switch 168. An analog telephone 172 is coupled to the Ethernet switch 168 via a VOIP 174. Alternatively, an IP telephone may be coupled to the Ethernet switch 168. The wireless communication with the mobile unit 108 is provided by another access point 176 having a pair of diversity omni-directional antennas 178. The portable unit 160 may be powered in various means, such as plugging the portable unit 160 into a wall outlet 180 and distributing the electrical power to the other components 166-178 via a power supply 182, such as a surge protection power strip.

The internal data network 142 of the mobile unit 108 and the internal data network 178 of the portable unit 160 thus operate seamlessly via the wireless communication as a remote data network 183. In some applications, additional wireless communication channels in either or both of the mobile unit 108 and the portable unit 160 would allow linking additional remote sites together into a larger remote data network 178. For instance, one portable unit 160 that is closer to the mobile unit 108 may act as a relay for another portable unit 160 that is beyond wireless communication range with the mobile unit 108. As another example, two mobile units 108 may wirelessly communicate with one another to expand the remote data network 183.

The mobile unit 108 is coupled to the satellite communication channel 102 is a manner that allows a non-technically trained individual to quickly and accurately align a VSAT antenna 184. This VSAT antenna 184 transmits and receives information in conjunction with a transceiver 186 coupled to the IP satellite modem 118. In particular, a powered antenna positioning mechanism 188 receives a geographic position signal from a Global Positioning System (GPS) device 190, a vehicle heading signal from a fluxgate compass 192, and a carrier detect (CD) signal and automatic gain control (AGC) signal both from the IP satellite modem 118.

The latitude and longitude information from the GPS 190, the current heading information from the compass 192, and the selected satellite orbital position is used to mathematically calculate the azimuth, elevation and polarity coordinates for the antenna position. The antenna positioning unit 188 internally senses an absolute elevation angle of the antenna 184, thus allowing accurate pointing on uneven ground.

Once the antenna 184 is approximately positioned, the azimuth is varied automatically in a scan pattern to acquire the satellite 106. The scan rate is based on the time required for the IP satellite modem 118 to acquire a signal. A rapid carrier acquisition time (e.g., less than a second) is thus very desirable in order to support practical antenna skewing rates. Once a CD signal is detected that indicates the appropriate dual carrier signal is sensed, then the scan is automatically fine-tuned to optimize the AGC signal. Until the correct satellite is confirmed, a manual or automatic transmit enable device 194 prevents inadvertent transmission from the mobile unit 108, which could violate FCC regulations if interfering with the wrong satellite.

The carrier detect capability provides a high likelihood that the correct satellite has been acquired, especially in combination with approximate antenna positioning. An example of signal characteristics that are analyzed for detecting the carrier include a selected center frequency such as 14.0145 GHz, turbo product encoding, 460 kbits/sec data rate, three-quarters forward error correction, and quadrature phase shift keying (QPSK). This high confidence in satellite acquisition eliminates the need for an expensive spectrum analyzer and the need for trained personnel.

FIG. 3 depicts another version of the universal teleconferencing system 100 that advantageously illustrates even greater mobility and an alternative to permanent installation in a vehicle. Like components are given the same numerals as depicted in FIG. 2, and the description given above is generally applicable to FIG. 3. One departure from the MCO mobile unit 108 of FIG. 2 to a transportable communication system (TCS) mobile unit 196 of FIG. 3 is that the equipment is selected for being readily broken down for placement in shippable containers 198 or for being retrofitted onto a vehicle of choice (e.g., smaller car or truck, off-road vehicle, Satellite News Gathering (SNG) van).

The TCS mobile unit 196 advantageously includes a cost-effective manual antenna positioning mechanism 200 with a simplified means for aligning the VSAT antenna 184 over the generally known approaches. The antenna 184 is approximately positioned with reference to lookup tables and knowledge of the approximate geographic position and heading orientation of the antenna 184. Then the positioning mechanism 200 is manually scanned until the CD signal activates a horn 202. Thereafter, the alignment is fine-tuned by maximizing the power of the AGC signal with reference to a voltmeter 204. It will be appreciated that the rate of manually scanning would be in relation to the acquisition time of the IP satellite modem 118. Consequently, rapid carrier detect of less than a second is desirable. It should be appreciated that this cost effective approach to antenna positioning is quick and does not require trained personnel nor an expensive spectrum analyzer.

The universal teleconferencing system 100 of FIG. 3 further illustrates additional mobility by using a portable unit, depicted as a Video Interactive Companion (VIC) portable unit 206. A self-contained power source 208 allows use in remote areas without an electrical outlet or generator (e.g., a construction site, accident/disaster location). In the illustrative embodiment, several rechargeable batteries 210 provide power to an inverter generator DC/AC 212 that produces single-phase 110 VAC power for the VIC portable unit 206 the internal digital network 166 and the VTC station 158. Linear power supplies 214 regulate the power in a low noise fashion to avoid performance degradation, whereas some switching power supplies, for instance, may generate too much RF noise to be usable in this application.

The VIC portable unit 206 is intended for VTC use only, and as such the end user has access to the VTC station 158, which is controllable by a VTC Infrared (IR) controller 216. Display is provided by a video monitor 218 and audio by an audio speaker 220 amplified by an audio power amplifier 222. The VTC station 158 is physically depicted as being mounted on a rollaway tripod 224 to allow easy movement and use, with a microphone 226 and an IR receiver 228 of the VTC station 158 positioned on the tripod 224.

FIG. 4 an alternative portable unit 250, depicted as a wearable interactive companion (WIC) 250, achieves an even greater degree portability. In the illustrative version, an assembly of 11 lbs is affixed to straps or a harness for hands off use. Thereby, a user may walk, climb or perform other functions while in full interactive 802.11X wireless communication with other portions of a universal teleconferencing system 252 via a mobile unit 254 to receive public Internet, h.323/H.320 video conferencing gateway, or plain old telephone system (POTS).

A lightweight internal digital network 256 is formed in part by a handheld PC 256, such as a PANASONIC TOUGHBOOK, installed into a port replicator 260, such as PANASONIC model CF-VEB071W. The wearer inputs audio via a microphone 266 and receives audio via either a headset 268 and/or a speaker 270. Videoteleconferencing from the WIC 250 is from a portable VTC 272, such as a POLYCOM VIAVIDEO. For zoom capability and increased performance in daylight environments, a zoom video camera 274 may advantageously be connected to the video input of the VTC 272. A wireless LCD touch screen display 276 that is powered by a battery 278 includes a graphical user interface 280 for selecting control options 282. Such an option may be a numeric or alphanumeric keypad 284 for dialing a VTC or POTS or URL location. The GUI 280 then displays video or data 286. Power for the system is advantageously augmented by batteries 258,

It will be appreciated that a number of applications would benefit from such a WIC portable unit 250. For example, a technician could repair a system at a remote location with a specialist remotely assisting. In addition, the wearer could hand the display 276 to another individual with the wearer then acting as cameraman. As another example, a rescue animal such as a German shepherd dog could wear the WIC portable unit 250 in order to access trapped individuals. Outside individuals would be able to communicate and assess the situation more fully. Moreover, a port on the port replicator could be connected to other devices, such as a transponder, that could be remotely released at the site so that human rescuers could locate the individuals.

It will be appreciated that the alignment of the VSAT antenna has been described above as both automatic and manual, with both versions assuming a stationary mobile unit 108, 196. However, in some applications, the additional expense of a stabilized satellite antenna (e.g., a Sea Tel Inc., Series 96 or Series 97) would be warranted in order to be used on a moving vehicle or platform,. As yet a further alternative, an electronically steerable antenna (e.g., antenna phased array) may be used for either a stationary or moving mobile unit 108, 196.

It will be further appreciated that the universal teleconferencing system 100 described above has a great many applications enabled by the simplicity, quality, flexibility and economy inherent therein. For example, distance education (e.g., grade school, high school, college, continuing and professional education) is enhanced by observing specific teachings without leaving the classroom. Through the use of live two-way video and audio it will greatly enhance the student's education and add much interest by two-way live interaction. Agriculture is a great example. The van 144 can be deployed in the middle of a cornfield and classes on Soil Management can be delivered. The same goes for classes on insect control, observation of construction tradesmen, and many others.

Many other interests such as engineering, construction, archeology and geology as the students will benefit from the mobility and capabilities of the van. The same for Engineering students such as Mechanical and Construction majors. This system will bring the students to the real world and give them an up close and a virtual hands-on experience anywhere. Teaching and administrative programs can perform live virtual tours, visits, or even interviews with the people and places that made a specific program successful. Continuing education for the teachers and administration themselves. Spontaneous virtual tours for students to enhance teacher efforts in the elementary and middle school classes. All of these applications increase the educators and students involvement because of the impact and participation that is apparent within the students and staff.

This is why “distance education” at fixed location end to end systems were installed—to increase student's participation, attentiveness and deliver to the student's course content they would not be able to receive at their current school. The universal teleconferencing system 100 allows mobility and allows the teachers and students live visual and audio two-way mobile communications. Distance education was originated to maximize educator's efficiency without increasing expenditures (reducing or eliminating travel expenses). Schools are finding new and creative ways to maximize their schools curriculum though distance education therefore, increasing applications for the van and the system. Schools will be adding many more video and audio conferencing systems (in almost all schools) in the next few years which when combined with a link up to a mobile system greatly increases possibilities to learn and observe live transmission thus making distance education the rule not the exception.

As another example, telemedicine applications are one of the areas where immediate impact can be seen through the use of the universal teleconferencing system 100. The mobile unit 108, 196 is a flexible system. All of the electronic scopes and other technologies available for medical field use within video conferencing and other media's can be incorporated within the mobile unit 108, 196. The mobile unit 108, 196 can be deployed to this accident and the connection back to a hospital can be made, basically, as quickly as an ambulance could reach the site. The ambulance itself could be even outfitted with the capabilities of the mobile unit 108, 196. At the hospital, the specialized doctor or a group of doctors could visually assess the situation and determine the best treatment immediately. The doctors remain on staff, their duties interrupted for the least possible time and now they know exactly what to be prepared for and when the ambulance does arrive. Preparation for the patient can be done and staff can be put on notice.

The mobile unit could be utilized as a mobile “doctors office”. With the aid of Registered Nurses or trained medical technicians, the doctors back at the offices or hospital could visually and electronically, diagnose and administer care for many different groups of people (nursing homes, elderly care facilities, children's homes, under-privileged families, special education facilities, and many more). Doctor signed prescriptions and other documentation could also be completed. This scenario maximizes doctor efficiency, minimizing hospital expenses for doctor travel time an off campus expenses. Diagnostic accuracy is enhanced by the interactive and real-time video and audio from the patient and attending staff.

Rural medicine in general has great needs for telemedicine. The current problem is that rural doctors do not have broadband capabilities at their rural locations. The mobile unit 108, 196 may be deployed to link with hospitals or rural offices to supply the care and doctor specialty that may be lacking within this scenario. The mobile unit 108, 196 delivers the doctor care and expertise needed to help these patients. Telemedicine for disaster scenarios lends itself to a mobile communication system. All of these applications for telemedicine do one main thing. Close or eliminate the gap between distance and time and immediate care.

Yet another example is general business usage wherein the mobile unit 108, 196, with the additional option of the portable unit 160, 206, may also be used as a medium to deliver video, audio, and data to an existing facility that may not have video conferencing capabilities or ISDN connectivity. In these types of circumstances external connections, media devices such as individual cameras, monitors or display devices, speakers and microphones can be delivered to an existing facilities boardroom, hotel meeting room, convention center, or a specific office. These business uses could include legal proceedings or consultations, sales training meetings, more personal visitations between deployed military and civilians with their families back home, intergovernmental or intragovernmental conferences, meetings held from construction sites, crime scene investigations, and rescue and recovery operations at aircraft or train crash sites.

The media devices could be deployed within a few feet or thousands of feet and the cabling or wiring technique can be used in conjunction with the wireless systems. The usage of a mobile unit for business usage provides flexibility and instant response time for many uses, which will also provide an extra benefit for permanent documentation and cost savings. Typical video conferencing sessions are conducted between two predetermined locations. This is called Point-to-Point. In the past these Point-to-Point sessions were limited to locations that currently have video conferencing equipment and digital telephone line service or ISDN service. This limited not only the effectiveness of video conferencing within this application area, but more importantly, the desire to use this technology. With the deployment of video conferencing equipment to business growing each year, some of the past anxieties have diminished, yet the flexibility to do video conferencing anywhere at anytime is still the desired need. This is why the van and the system will be successful for business use.

Typically within businesses, monthly, quarterly, bi-yearly, or yearly sales, product development, product engineering, marketing, and other meetings are held at a single location, usually a hotel. The hotel, food, car rental, general business expenses, and other related travel expenses that accompany these practices are very costly. Needless to mention that loss of productivity, which is virtually an unknown expense to a company. Each person will typically lose a day of travel in each direction and an average of two days with the meeting.

With the mobile unit 108, 196, conducting videoconferences at company locations can minimize expenses. This could mean one van could visit of the regions individually or have multiple vans all connected together at the same time (turning a Point-to-Point video conferencing into a Multi-Point or in other words, “bridge” the video conferencing to include every location at once).

For occasional uses, the van could be delivered directly to a business for standard Point-to-Point video conferencing or multi-point. The participant(s) would then use the van itself as the meeting place or use a room within their own facility. The circumstance is used when a business with video conferencing wishes to connect to a customer or another business that does not have a video conferencing system.

Another application may be when the need does not allow enough time for ISDN or digital telephone lines to be installed. The van may also be used as a connection device until these ISDN or digital telephone lines can be installed. The system may also be used as a redundant system or back up for “high profile” type of applications. ISDN or digital telephone lines are more vulnerable to down time than satellite transmissions. Therefore, the need and desire to back-up this transmission is growing. Again, because the system is a Wireless Mobile Satellite delivered solution, all of these Business Forum Applications can be done within a moment's notice at any locations with the predetermined area (i.e. North America).

As yet a further example, accident and environmental mishaps may be more accurately surveyed by the appropriate personnel. For instance, insurance claims given to an insurance adjuster may be reviewed for an insurance loss by observing a live two-way interview over the system 100. In addition, documenting the damage may be performed through a remote camera with the capabilities of recording live video and audio for their file. The system allows for still JPEG pictures as desired and the ability to collaborate on documents and/or drawings. In general, adjusters can adjust a claim at a distance. It can also be used to document fire scenes by fire trained Cause and Origin personnel. For an environmental or other biohazard (e.g., epidemic), decision makers may be kept up to date on the situation without risking their own health. As yet an addition example, disaster response may require that a large number of functions be set up in a remote location, or in a location that has lost its terrestrial communication networks.

FIGS. 5 and 6 depict a sequence of operations that illustrate the universal teleconferencing system 100 of FIGS. 2-3 in use. With particular reference to FIG. 5, a method is depicted for remote-to-terrestrial two-way video, audio and data communication (block 300). Two narrow-band satellite channels are allocated from an operator of a communication satellite (block 302). These bands are narrow as compared to traditional satellite video broadcast, although the amount of bandwidth acquired would be commensurate with the anticipated communication demand. For example, additional bandwidth may be required if operating a deployable command center with a large number of telephones.

The remote satellite antenna is then aligned to the communication satellite (block 304), which is described in more detail in FIG. 6. Then, the packet-based satellite communication channel is established between the technical operations center and the mobile unit (block 306). The technical operations center is interfaced to one or more terrestrial communication networks (ISDN, POT, ISP) (block 308). Similar, the mobile unit is also interfaced to a mobile communication network at the remote site, such as equipment installed aboard a van, ship or assembled in the field (block 310). Advantageously, the mobile unit may further expand the reach to another remote site via a wireless two-way transmission to a portable unit (block 312). Then, the two-way communication (e.g., video, audio, data) is conducted from either or both of the mobile unit and the portable unit to a terrestrial communication network using the satellite communication channel (block 314).

FIG. 6 describes block 304 of FIG. 5 for remote satellite antenna alignment. It will be appreciated that the steps described herein would be performed continuous or at least intermittently for application wherein the position of either or both of the communication satellite and the satellite antenna is not stationary during transmission. Beginning in block 320, transmission is disabled to avoid inadvertent interference with another system. The geographic location and heading of the antenna is obtained (block 322). This may be a manual procedure of referring to a map, compass, and satellite reference table. This information may be provided by navigation equipment (e.g., GPS, inertial navigation unit, etc.).

The antenna is then approximately positioned to the approximate position of the satellite (block 324). The scan volume depends on the uncertainty in the azimuth and elevation information available and the accuracy in positioning the antenna to the selected position. For example, lack of any heading information may require scanning a complete circle in azimuth. Similarly, having no elevation information (e.g., a MCO mobile unit parked on an inclined surface), may necessitate scanning a larger volume.

Then, a systematic coarse scan is performed over the scanning volume (block 326). This could include an outward spiral pattern or a raster pattern, for instance. While the coarse scan is underway, the carrier detect signal is monitored, wherein the specific frequency and other modulations characteristics of the dual carriers are detected (block 328). Once detected, fine-tuning of the antenna position is performed (block 330) by scanning a smaller volume about the detected position. Once a maximized carrier signal power is detected (e.g., power falls off in any direction in azimuth and elevation from this point) (block 332), then the satellite antenna is enabled for transmission (block 334). The antenna is maintained in this position as required (block 336), especially for moving platforms.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art. For example, it will be appreciated by those skilled in the art that numerous arrangements of an internal digital network 128 may be used consistent with aspects of the invention. Moreover, the connections to depicted terrestrial communication networks 110-114 is illustrative only and that other fewer or additional connections to various types of communication networks. For example, the TOC 104 may further facilitate communication between two mobile units 108, or with another type of communication network (e.g., cellular telephone).

As an additional example, some applications will require different combinations of communication systems at the remote location. For example, a multiple number of VIC portable units 206 may be used in combination with a MCO mobile unit 208 having additional wireless channels (i.e., additional access points 162 and diversity omni-directional antennas 164).

As yet a further example, although a geosynchronous communication satellite 18 is advantageously described herein for relaying a satellite communication channel, aspects of the present invention may include other broadcast electromagnetic communication links between the TOC and the mobile unit, such as a nongeosynchronous communication satellite and an airborne communication relay. Moreover, the wireless communication channel between the mobile unit and the portable unit may comprise various electromagnetic frequency bands, such as a modulated coherent light source or sources, a microwave frequency band, a Radio Frequency (RF) band, etc.

As yet an additional example, the wireless communication channel may have advantageous use in some applications even without a satellite communication channel. For instance, a facility may have access to a terrestrial communication network with a desired teleconferencing site spaced from the access point. Thus, a wireless communication channel, such as to a VIC portable unit 206, may allow convenient positioning of the teleconferencing capability. In this instance, the mobile unit would be in communication with the terrestrial communication network.

Alternatively, a number of teleconferencing remote sites may all be within wireless communication distance from a mobile unit, which establishes the wireless communication channels between these plurality of portable units. Such a scenario would have direct application to a natural disaster wherein coordination amongst people within a relatively small geographic area is required. Biological hazards, destroyed local telephone systems, or impassable roadways may make an in-person meeting or traditional communication impractical.

What is claimed is:

1. A remote teleconferencing system for two-way audio, video and data communication with a videoconferencing device that is in electronic communication with a terrestrial communication network, the system comprising:
a technical operation center operably configured to exchange two-way audio, video and data communication between a communication satellite and the terrestrial communication network; and
a mobile teleconferencing system operably configured for two-way audio, video and data communication with the communication satellite.

2. The remote teleconferencing system of claim 1, further comprising:
a wireless teleconferencing system operably configured for generating and presenting two-way audio, video and data communication to an end user, and further operably configured for wireless communication to the mobile teleconferencing system.

3. The remote teleconferencing system of claim 1, wherein the terrestrial communication network comprises a digital telephone network, the technical operational center further comprising a digital telephone interface in selective telephony communication with a fixed videoconference location.

4. The remote teleconferencing system of claim 1, wherein two-way audio, video and data communication further comprises an analog telephone signal, the technical operational center is further configured to switch the analog telephone signal to an analog telephone network.

5. The remote teleconferencing system of claim 1, wherein the terrestrial communication network comprises a digital data network, the technical operational center further comprising a data router in electronic communication with the digital data network.

6. A method for remote teleconferencing two-way audio, video and data communication, comprising:
exchanging two-way audio, video and data communication between a communication satellite and a terrestrial communication network; and
transmitting two-way audio, video and data communication with the communication satellite from a remote location.

7. The method of claim 6, wherein transmitting two-way audio, video and data communication further comprising:
wirelessly relaying the two-way audio, video and data communication to another remote location.

8. The method of claim 6, wherein exchanging communication between the satellite and the terrestrial communication network further comprises:
interfacing to a digital telephone network to communicate with a selective fixed videoconference location.

9. The method of claim 6, wherein exchanging communication between the satellite and the terrestrial communication network further comprises:
switching an analog telephone signal contained in the communication to an analog telephone network.

10. The remote teleconferencing system of claim 1, wherein the terrestrial communication network comprises a digital data network, the technical operational center further comprising a data router in electronic communication with the digital data network.

11. A method of aligning a Very Small Aperture Terminal (VSAT) antenna to a geosynchronous satellite for two-way video, audio, and data communication for remote teleconferencing, comprising: designating a plurality of carrier signal characteristics to specify a unique carrier;
positioning the VSAT antenna to an approximate position of the satellite;
scanning the VSAT antenna to receive carrier signals;
detecting the unique carrier having the plurality of carrier signal characteristics;
sensing a power level of the unique carrier; and
fine tune scanning the VSAT antenna to increase a sensed power of the first and second carrier signals.

12. The method of claim 11, wherein detecting the first and second carrier signals further comprises:
generating a carrier detect signals in response to detecting both the first carrier signal at the first frequency and the second carrier signal at the second frequency.

13. The method of claim 11, wherein generating the carrier detect signal requires an acquisition time, the scanning of the VSAT antenna further comprising:
determining a scan rate related to the acquisition time; and
scanning the VSAT antenna at a rate not to exceed the scan rate.

14. A mobile teleconferencing apparatus for communicating via a broadcast electromagnetic signal to a terrestrial communication network, comprising:
a satellite antenna;
a transceiver coupled to the satellite antenna;
a satellite modem operable to interface to the broad electromagnetic signals via the transceiver and satellite antenna;
a remote data network coupled to the satellite modem; and
a teleconferencing system coupled to the remote data network.

15. The mobile teleconferencing apparatus of claim 14, further comprising a vehicle configured to transport the satellite antenna, transceiver, satellite modem, internal data network, and teleconferencing system.

16. The mobile teleconferencing apparatus of claim 15, wherein the satellite antenna comprises a stabilized satellite antenna and the vehicle comprises a ship.

17. The mobile teleconferencing apparatus of claim 15, wherein the vehicle comprises a wheeled vehicle including an office space having the teleconferencing system mounted for use in the office space.

18. The mobile teleconferencing apparatus of claim 14, further comprising a telemedicine device coupled to the remote data network.

19. The mobile teleconferencing apparatus of claim 14, further comprising a plurality of telephones interfaced to the remote data network.

20. The mobile teleconferencing apparatus of claim 14, wherein the satellite modem relays packet-based digital communication.
